(19) United States
(12) Patent Application Publication
(10) Pub. No.: US 2024/0076436 A1
(43) Pub. Date: Mar. 7, 2024

(54) POLYURETHANE FOAM COMPOSITION AND USE OF SAME FOR POTTING PRODUCTS

(71) Applicant: Dow Global Technologies LLC, Midland, MI (US)

(72) Inventors: Jingming Cao, Shanghai (CN); Yudong Qi, Shanghai (CN); Weiyue Tian, Shanghai (CN)

(21) Appl. No.: 18/259,612

(22) PCT Filed: Mar. 10, 2021
(86) PCT No.: PCT/CN2021/079884

§ 371 Date: Jun. 28, 2023

(51) Int. Cl. C08G 18/08; C08G 18/12; C08G 18/18; C08G 18/20; C08G 18/48; C08J 9/00; C08J 9/12; C08J 9/14; C08K 5/521

(52) U.S. Cl. CPC C08G 18/14; C08G 18/12; C08G 18/1816; C08G 18/1875; C08G 18/2018; C08G 18/4816; C08G 18/4845; C08J 9/0038; C08J 9/0061; C08J 9/125; C08J 9/146; C08K 5/521; C08G 2101/00

(57) ABSTRACT

The present disclosure relates to a polyurethane foam composition, comprising (A) a polyol component, comprising one or more polyols selected from the group consisting of a polyester polyol, a polyether polyol, and the combination thereof, wherein the one or more polyols have an average hydroxyl group functionality of from 3 to 7 and an average hydroxyl group number of from 300 to 1000 mg KOH/g; and (B) an isocyanate component, comprising one or more isocyanate compounds; wherein in either or both of the (A) polyol component and the (B) isocyanate component, the polyurethane foam composition further comprises one or more flame retardants in an amount of no more than 15 percent by weight based on the total weight of the polyurethane foam composition, and, one or more blowing agents; and wherein the NCO/OH ratio of the isocyanate component to the polyol component is within the range of from 0.5:1 to 5:1. The present disclosure further relates to a method for potting a battery by using the polyurethane foam composition.

### FIELD OF THE DISCLOSURE

The present disclosure relates generally to a polyurethane foam composition. In particular, the present disclosure relates to a two-component polyurethane foam composition and a method for potting products by using the same. The polyurethane foam composition exhibits a balanced reactivity profile during application, and provides the formed foam with improved physical properties and adherence to stringent flammability standards with a low level of flame retardants.

### BACKGROUND

Currently, multi-layer cylinder batteries piled up with small gaps are used to increase the battery energy density. It is required that cured potting materials have satisfactory physical properties and electrical stability to ensure long term stability of the battery under various use conditions such as vibration, high temperature and high humidity. In addition, the potting material needs to show a balanced reactivity profile. It is desirable that the reacting potting agent displays an initial low viscosity and sufficiently slow viscosity increase enabling sufficient flow ability to fill the gaps in the battery pack, while also curing fast enough to enable quick demolding and therefore short molding cycle time.

The potting technologies currently used often fail to provide satisfactory physical performances and still need to include elevated amounts of solid and/or liquid flame retardants to meet the required V0 flammability performance according to the UL-94 Standard.

Therefore, there is still a need in the art for a potting agent that facilitates a time efficient and thus more cost-efficient process for potting products, for example, battery packs, that further offers the desired stability/durability over their operation lifetime.

### SUMMARY OF THE DISCLOSURE

The inventors have developed a two-component composition that exhibits a desired flow profile and forms foams with reduced flame retardants and improved physical properties for use as a potting material.

In one embodiment, the present disclosure describes a polyurethane foam composition, comprising:
(A) a polyol component, comprising one or more polyols selected from the group consisting of a polyester polyol, a polyether polyol, and the combination thereof, wherein the one or more polyols have an average hydroxyl group functionality of from 3 to 7 and an average hydroxyl group number of from 300 to 1000 mg KOH/g; and
(B) an isocyanate component, comprising one or more isocyanate compounds;
wherein in either or both of the (A) polyol component and the (B) isocyanate component, the polyurethane foam composition further comprises one or more flame retardants in an amount of no more than 15 percent by weight based on the total weight of the polyurethane foam composition, and, one or more blowing agents; and
wherein the NCO/OH ratio of the isocyanate component to the polyol component is within the range of from 0.5:1 to 5:1.

In another embodiment, the present disclosure describes a polyurethane foam prepared from the polyurethane foam composition according to the present disclosure, wherein the polyurethane foam comprises no more than 15 percent by weight of a flame retardant, based on the total weight of the polyurethane foam, wherein the polyurethane foam has a tensile strength of higher than 3.5 MPa at 25° C., and wherein the polyurethane foam has a thermal conductivity of less than 0.05 W/(m·K) at 23° C.

In another embodiment, the present disclosure describes a method of potting a product (for example, a battery) using the polyurethane foam composition of claim 1, comprising:
(i) providing the polyurethane foam composition according to the present disclosure;
(ii) forming a reaction mixture by mixing the (A) polyol component with the (B) isocyanate component; and
(iii) injecting the reaction mixture into an enclosed space of the battery and allowing the reaction mixture to react, expand and cure.

In another embodiment, the present disclosure describes a potted product (for example, a potted battery) comprising the polyurethane foam as described.

In another embodiment, the present disclosure describes use of the polyurethane foam composition as described for potting products (for example, a battery).

It is to be understood that both the foregoing general description and the following detailed description are exemplary and explanatory only and are not limiting in any way.

### BRIEF DESCRIPTION OF THE DRAWINGS

FIG. 1 is a photograph of polyurethane foam prepared without cylinder batteries as potting resin for batteries, according to the present disclosure.

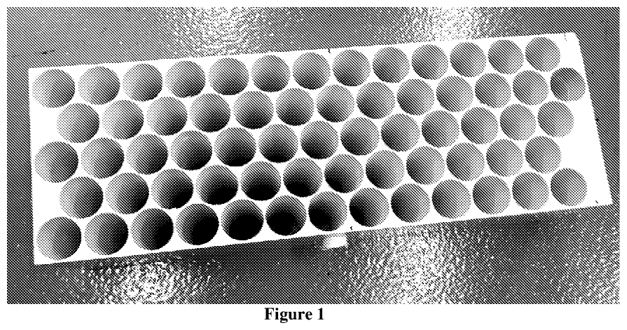

### DETAILED DESCRIPTION OF THE DISCLOSURE

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated.

As disclosed herein, all percentages mentioned herein are by weight, and temperatures in ° C., unless specified otherwise.

Polyurethane Foam Composition

The polyurethane foam composition according to the present disclosure is a two-component composition comprising (A) a polyol component and (B) an isocyanate component.

As used herein, the term “two-component” means that the polyurethane foam composition is provided in parts separated from each other before use. Typically, the composition according to the present disclosure can include at least a first component comprising one or more polyols selected from the group consisting of a polyester polyol, a polyether polyol, and the combination thereof (also referred to herein as a “polyol component”, “polyol component (A)”, or “OH component”), and a second component comprising one or more isocyanate compounds (also referred to herein as an “isocyanate component”, “isocyanate component (B)”, or “NCO component”). The polyol component and the isocyanate component can be prepared, stored, transported and served separately, and combined shortly or immediately before being applied to, for example, products to be potted. It is contemplated that when these two components are brought into contact, a curing reaction begins in which the polyol groups react with the isocyanate groups to form urethane links. The reactive polyurethane dispersion formed by bringing the two components into contact can be referred to as a “reaction mixture” or a “curable mixture.”

In some embodiments, the NCO/OH ratio of the isocyanate component to the polyol component comprised in the polyurethane foam composition can be within the range of from 0.5:1 to 5:1. In some embodiments, NCO/OH ratio of the isocyanate component to the polyol component can be within the range obtained by combining any two of the following endpoints: 0.5:1, 0.8:1, 1:1, 1.2:1, 1.5:1, 1.8:1, 2:1, 2.2:1, 2.5:1, 3:1, 4:1, and 5:1. In some specific embodiments, the NCO/OH ratio of the isocyanate component to the polyol component can be within the range of from 0.5:1 to 4:1, or from 0.5:1 to 3:1, preferably from 0.5:1 to 2.5:1, from 0.8:1 to 3:1, from 0.8:1 to 2.5:1, from 1:1 to 2.5:1, from 1.2:1 to 2.2:1, or from 0.8:1 to 2.0:1; and more preferably from 0.8:1 to 1.8:1, from 1:1 to 2:1, from 1.2:1 to 2:1, or from 1:1 to 1.8:1.

As used herein, the term “NCO/OH ratio” refers to the ratio of the number of isocyanate groups to the number of hydroxyl groups in the polyurethane foam composition; or more specifically, the ratio between the number of isocyanate groups in the isocyanate component and the number of hydroxyl groups in the polyol component, of the polyurethane foam composition according to the present disclosure.

The polyurethane foam composition according to the present disclosure further comprises one or more blowing agents. The one or more blowing agents can be comprised in the polyol component or the isocyanate component. The blowing agent used in the polyurethane foam composition includes at least one physical blowing agent which is selected from a hydrocarbon, hydrofluorocarbon, hydrochlorofluorocarbon, fluorocarbon, dialkyl ether or fluorine-substituted dialkyl ether, or any combination thereof. Blowing agents of these types include propane, isopentane, n-pentane, n-butane, isobutane, isobutene, cyclo-pentane, dimethyl ether, 1,1-dichloro-1-fluoroethane (HCFC-141b), chlorodifluoromethane (HCFC-22), 1-chloro-1,1-difluoroethane (HCFC-142b), 1,1,1,2-tetrafluoroethane (HFC-134a), 1,1,1,3,3-pentafluorobutane (HFC-365mfc), 1,1-difluoroethane (HFC-152a), 1,1,1,2,3,3,3-heptafluoropropane (HFC-227ea), 1,1,1,3,3-pentafluoropropane (HFC-245fa), hydrofluoroolefin (HCFO), hydrofluoroolefin (HFO) such as LBA, and any combination thereof. The polyurethane foam composition can also comprise a chemical blowing agent, such as water, carboxylic acid, formic acid, and any combination thereof.

The one or more blowing agents can be comprised in either or both of the polyol component and the isocyanate component. In some embodiments, the one or more blowing agents are comprised in the polyol component. Typically, the blowing agent constitutes from 1 to 20 parts by weight per 100 parts by weight the polyol component.

The polyurethane foam composition according to the present disclosure further comprises one or more flame retardants. The one or more flame retardants can be comprised in the polyol component and/or the isocyanate component. As used herein, the terms “flame retardants” and “fire retardants” refer to a variety of substances that are added to combustible materials to prevent fires from starting or to slow the spread of fire and provide additional escape time. Such flame retardants include for example exfoliating graphite, phosphonate esters, phosphate esters, halogenated phosphate esters or a combination thereof. Phosphonate esters for use in the present invention can be represented by the formula R—P(O)(OR′)(OR″) where R, Rand R″ are each independently an alkyl having 1 to 4 carbon atoms. Preferred members of this group are dimethyl methylphosphonate (DNvMMP) and diethyl ethyl phosphonate (DEEP). Phosphate esters which can be used in the present disclosure are trialkyl phosphates, such as triethyl phosphate (TEP), and tricresyl phosphate. Halogenated phosphate esters which are associated with fire retardation are known in the art and can be represented by the general formula P(O)(OR′X′n)(OR″X″n)(OR′″X′″n), where R′, R″ and R′″ are each independently an alkyl having 1 to 4 carbon atoms, X′, X″ and X′″. are each independently a halogen and n is an integer from 1 to 3. Examples of halogenated phosphate esters include 2-chloroethanol phosphate; 1-chloro-2-propanol phosphate [tris(1-chloro-2-propyl) phosphate] (TCPP); 1,3-dichloro-2-propanol phosphate also called tris(1,3-dichloro-2-propyl) phosphate; tri(2-chloroethyl) phosphate; tri(2,2-dichloroisopropyl) phosphate; tri(2,3-dibromopropyl) phosphate; tri(11,3-dichloropropyl)phosphate; tetrakis(2-chloroethyl) ethylene diphosphate; bis(2-chloroethyl) 2-chloroethylphosphonate; cliphosphates [2-chloroethyl diphosphate]; tetrakis(2-chloroethyl)ethylenediphosphate; tris-(2-chloroethyl)-phosphate, tris-(2-chloropropyl)phosphate, tris-(2,3-dibromopropyl)-phosphate, tris(1,3-dichloropropyl)phosphate tetrakis (2-chloroethyl-ethylene diphosphate and tetrakis(2-chloroethyl) ethyleneoxyethylenediphosphate. Tribromonopentyl chloroalkyl phosphates having the formula [(BrCH₂)₃C—CH₂O], PO(OCYHCH₂Cl)₃— where Y represents a hydrogen, an alkyl having 1 to 3 carbon atoms, or chloroalkyl group and n is from 0.95 to 1.15 may also be used. In some specific embodiments, the flame retardant is trichloropropylphosphate and/or triethyl phosphate. In some embodiments, the one or more flame retardants comprised in the polyurethane foam are selected from non-solid flame retardants.

Typically, from 1 to 40 parts by weight of a flame retardant per 100 parts by weight the polyol component are included. In some embodiments, from 1, 3, 5, 7, 10, 12, 15, 16, or 18, to 20, 25, 30, 35 or 40 parts by weight of a flame retardant per 100 parts by weight the polyol component are included. In some embodiments, the amount of the flame retardant comprised is within the range of from 5 to 40, from 5 to 30, from 5 to 25, or from 5 to 20 parts by weight the polyol component.

In some embodiments, the amount of one or more flame retardants comprised in the polyurethane foam composition is no more than 15 percent by weight, based on the total weight of the polyurethane foam composition. In some embodiments, the flame retardant is used in a certain amount so that the level of the flame retardant in the formed foam is no more than 15 percent by weight of the final foam. Preferably the flame retardant is from 1 to 15 percent by weight of the formed foam. It is found that the polyurethane foam formed from the polyurethane foam composition according to the present disclosure meets the V0 flammability requirement in accordance with the UL-94 Standard with the inclusion of no more than 15 percent by weight of a flame retardant, based on the total weight of the formed foam.

In addition to the foregoing components, it is often desirable to have certain other ingredients present in the polyurethane foam composition for the purpose of facilitating the subsequent use in preparing cellular polymers. One or more of these ingredients can be comprised in the polyol component and/or the isocyanate component. Among these additional ingredients are catalysts, surfactants, preservatives, pigments, colorants, anti-oxidants, biological retarding agents, reinforcing agents, stabilizers and fillers.

In some embodiments, the polyurethane foam composition further comprises one or more catalysts, including tertiary amine compounds, organometallic compounds, and any combination thereof. Exemplary tertiary amine compounds include triethylenediamine, N-methylmorpholine, N,N-dimethylcyclohexylamine, N,N′,N′-dimethylaminopropylhexahydrotriazine, 2-hydroxy-N,N,N-trimethylpropan-1-aminium formate, pentamethyldiethylenetriamine, tetramethylethylenediamine, 1-methyl-4-dimethylaminoethylpiperazine, 3-methoxy-N-dimethylpropylamine, N-ethylmorpholine, diethylethanolamine, N-cocomorpholine, N,N-dimethyl-N′,N′-dimethyl isopropylpropylenediamine, N,N-diethyl-3-diethylaminopropylamine and dimethylbenzylamine. Exemplary organometallic catalysts include organomercury, organolead, organoferric and organotin catalysts. Suitable tin catalysts include stannous chloride, tin salts of carboxylic acids such as dibutyltin di-laurate, as well as other organometallic compounds such as are disclosed in U.S. Pat. No. 2,846,408. A catalyst for the trimerization of polyisocyanates, resulting in a polyisocyanurate, such as an alkali metal alkoxide may also optionally be employed herein. Such catalysts are used in an amount which measurably increases the rate of polyurethane formation. Typical amounts are 0.001 to 3 parts by weight of catalyst per 100 parts by weight the polyol component.

In some embodiments, the polyurethane foam composition further comprises one or more surfactants to stabilize the foaming reaction mixture until it cures. Such surfactants advantageously comprise a silicone surfactant, such as a liquid or solid organosilicone surfactant. Such surfactants are employed in amounts sufficient to stabilize the foaming reaction mixture against collapse and the formation of large, uneven cells. Typically, 0.2 to 3 parts by weight, preferably 1 to 2 parts by weight of the surfactant per 100 parts by weight the polyol component are suitable for this purpose.

It is understood that other mixtures or materials that are known in the art can be included in the polyurethane foam composition and are within the scope of the present invention.

The Polyol Component

The polyol component comprised in the polyurethane foam composition according to the present disclosure can comprise one or more polyols. In some embodiments, the polyurethane foam composition can comprise two or more polyols. In some embodiments, the one or more polyols comprised in the polyurethane foam composition can be selected from the group consisting of polyester polyols, polyether polyols, and the combination thereof.

As used herein, the term “polyol” refers to a compound with two or more hydroxyl groups. A polyol is a “diol” when it has exactly two hydroxyl groups, a “triol” when it has exactly three hydroxyl groups, a “tetraol” when it has exactly four hydroxyl groups, a “pentanol” when it has exactly five hydroxyl groups, and so on.

In some embodiments, the one or more polyols in the polyol component have an average hydroxyl group functionality of no lower than 3. In some embodiments, the one or more polyols in the polyol component have an average hydroxyl group functionality of no higher than 7. In some embodiments, the one or more polyols in the polyol component have an average hydroxyl group functionality of from 3, 3.2, 3.4, or 3.5, to 5, 5.6, 5.8, 6, 6.5 or 7. In some embodiments, the one or more polyols in the polyol component have an average hydroxyl group functionality of from 3 to 7, for example, from 3 to 6.8, from 3 to 6.5, from 3 to 6, from 3 to 5.8, from 3 to 5.6, from 3.4 to 7, from 3.4 to 6.8, from 3.4 to 6.5, from 3.4 to 6, from 3.4 to 5.8, or from 3.4 to 5.6.

In some embodiments, the one or more polyols in the polyol component have an average hydroxyl group number of greater than 300 mg KOH/g. In some embodiments, the one or more polyols in the polyol component have an average hydroxyl group number of smaller than 1,000 mg KOH/g. In some embodiments, the one or more polyols in the polyol component have an average hydroxyl group number of, for example, from 300, 305, 310, 315, 320, 325, or 330 to 700, 750, 800, 850, 900, 950 or 1000 mg KOH/g. In some embodiments, the one or more polyols in the polyol component have an average hydroxyl group number of from 300 to 1000 mg KOH/g, from 300 to 950 mg KOH/g, from 300 to 900 mg KOH/g, from 310 to 1000 mg KOH/g, from 310 to 950 mg KOH/g, from 320 to 1000 mg KOH/g, or from 320 to 950 mg KOH/g.

In some embodiments, the polyol component can comprise at least one polyester polyol. A compound that contains two or more ester linkages in the same linear chain of atoms is known herein as a “polyester.” A compound that is a polyester and a polyol is known herein as a “polyester polyol.”

The polyester polyols employed in the polyurethane foam composition can have a molecular weight not to exceed 10,000 g/mol.

In some embodiments, the polyester polyols can have a hydroxyl group functionality of at least 2 (i.e., f≥2). In some embodiments, the polyester polyols can have a hydroxyl group functionality of not to exceed 10 (i.e., f≤10). In some embodiments, the polyester polyols can have a hydroxyl group functionality within the range of from 2 to 8, from 2 to 7, from 3 to 7, from 3 to 6, or from 3 to 5.

In some embodiments, the polyester polyols can have a hydroxyl group number of greater than 300 mg KOH/g. In some embodiments, the polyester polyols can have a hydroxyl group number of smaller than 1,000 mg KOH/g. In some embodiments, the polyester polyols can have an average hydroxyl group number of from 300 to 950 mg KOH/g, from 300 to 900 mg KOH/g, from 310 to 1000 mg KOH/g, from 310 to 950 mg KOH/g, from 320 to 1000 mg KOH/g, or from 320 to 950 mg KOH/g.

In some embodiments, the polyester polyols include, but are not limited to, polycondensates of diols and also, optionally, polyols (e.g., triols, tetraols), and of dicarboxylic acids and also, optionally, polycarboxylic acids (e.g., tricarboxylic acids, tetracarboxylic acids) or hydroxycarboxylic acids or lactones. The polyester polyols can also be derived from, instead of the free polycarboxylic acids, the corresponding polycarboxylic anhydrides, or corresponding polycarboxylic esters of lower alcohols.

Suitable diols include, but are not limited to, ethylene glycol, butylene glycol, diethylene glycol, triethylene glycol, pentylene glycol, hexalene glycol, polyalkylene glycols, such as polyethylene glycol, and also 1,2-propanediol, 1,3-propanediol, 1,3-butanediol, 1,4-butanediol, 1, 6-hexanediol, and neopentyl glycol. If a polyester polyol functionality greater than 2 is to be achieved, polyols having a functionality of 3 or greater can optionally be included in the polyol composition (e.g., trimethylolpropane, glycerol, erythritol, pentaerythritol, trimethylolbenzene or trishydroxyethyl isocyanurate).

Suitable dicarboxylic acids include, but are not limited to, aliphatic acids, aromatic acids, and combinations thereof. Examples of suitable aromatic acids include phthalic acid, isophthalic acid, terephthalic acid, and tetrahydrophthalic acid. Examples of suitable aliphatic acids include hexahydrophthalic acid, cyclohexane dicarboxylic acid, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid, 2,2-dimethyl succinic acid, and trimellitic acid. As used herein, the term “acid” also includes any anhydrides of said acid. Further, monocarboxylic acids, such as benzoic acid and hexane carboxylic acid, should be minimized or excluded from the disclosed compositions. Saturated aliphatic and/or aromatic acids are also suitable for use according to this disclosure, such as adipic acid or isophthalic acid.

In some embodiments the polyol component can comprise at least one polyether polyol. A compound that contains two or more ether linkages in the same linear chain of atoms is known herein as a “polyether.” A compound that is a polyether and a polyol is a “polyether polyol.”

The polyether polyols employed in the polyurethane foam composition can have a molecular weight not to exceed 10,000 g/mol.

In some embodiments, the polyether polyols can have a hydroxyl group functionality of at least 2 (i.e., f≥2). In some embodiments, the polyether polyols can have a hydroxyl group functionality of not to exceed 10 (i.e., f≤10). In some embodiments, the polyether polyols can have a hydroxyl group functionality within the range of from 2 to 8, from 2 to 7, from 3 to 7, from 3 to 6, from 3 to 5.

In some embodiments, the polyether polyols can have a hydroxyl group number of greater than 300 mg KOH/g. In some embodiments, the polyether polyols can have a hydroxyl group number of smaller than 1,000 mg KOH/g. In some embodiments, the polyether polyols can have an average hydroxyl group number of from 300 to 950 mg KOH/g, from 300 to 900 mg KOH/g, from 310 to 1000 mg KOH/g, from 310 to 950 mg KOH/g, from 320 to 1000 mg KOH/g, or from 320 to 950 mg KOH/g.

In some embodiments, the polyether polyols for use in the present disclosure are obtained by the addition polymerisation of alkylene oxides with polyhydric alcohol starter compounds. Examples of such polyhydric alcohols include glycerin, sorbitol, sucrose, glucose, fructose, lactose or other sugars. In some embodiments, the starter compound is sorbitol or sucrose. These polyhydric alcohols as well as mixtures of these alcohols with water, glycerol, propylene glycol, ethylene glycol or diethylene glycol, may be used as starter compounds. Examples of suitable sorbitol- or sucrose/glycerine-initiated polyethers that can be used include Voranol™ 360, Voranol™ RN411, Voranol™ RN490, Voranol™370, Voranol™ 446, Voranol™ 520, Voranol™ 550, Voranol™ RN 482, Tercarol™ RF 55 or VORANOL™ RH 360 polyols, all available from The Dow Chemical Company.

In some embodiments, the polyurethane foam composition comprises from 50 to 95 parts by weight of one or more polyols per 100 parts by weight the polyol component, for example, from 55 to 95, from 60 to 95, from 65 to 90, or from 70 to 90 parts by weight of the one or more polyols per 100 parts by weight the polyol component. In a specific embodiment, the polyol component comprises at least 18 parts by weight, or at least 20 parts by weight of one or more polyols having a hydroxyl group functionality of at least 3.5, at least 3.8 or at least 4.0, per 100 parts by weight the polyol component.

In some embodiments, the polyol component can comprise one or more of the blowing agents and the flame retardants as described.

In some embodiments, the polyol component can further comprise one or more ingredients selected from catalysts, surfactants, preservatives, pigments, colorants, antioxidants, biological retarding agents, reinforcing agents, stabilizers, fillers, and any combination thereof, as described herein. In a specific embodiment, the polyol component can further comprise one or more selected from catalysts, surfactants, and combinations thereof.

In some embodiments, the polyol component can have a viscosity at 25° C. of from 200 cSt to 38,000 cSt, for example, from 200 cSt to 35,000 cSt, or from 250 cSt to 35,000 cSt, as measured according to ASTM D2196.

The Isocyanate Component

The isocyanate component comprised in the polyurethane foam composition according to the present disclosure can comprise one or more isocyanate compounds reactive with the one or more polyols in the polyol component.

In some embodiments, the isocyanate compound can be one or more selected from isocyanate monomers, isocyanate prepolymers, modified isocyanates and combination thereof.

As used herein, an “isocyanate monomer” is any compound that contains two or more isocyanate groups. An “aromatic isocyanate” is an isocyanate that contains one or more aromatic rings. An “aliphatic isocyanate” contains no aromatic rings. In some embodiments, the isocyanate compound comprises an aromatic isocyanate.

Isocyanate monomers suitable for use according to the disclosure can be selected from the group consisting of aromatic isocyanates, aliphatic isocyanates, carbodiimide modified isocyanates, and the combinations thereof. Examples of aromatic isocyanates suitable for use according to the disclosure include, but are not limited to, isomers of methylene diphenyl dipolyisocyanate (“MDI”) such as 4,4-MDI, 2,4-MDI and 2,2′-MDI, or modified MDI such as carbodiimide modified MDI or allophanate modified MDI; isomers of toluene-dipolyisocyanate (“TDI”) such as 2,4-TDI, 2,6-TDI, isomers of naphthalene-dipolyisocyanate (“NDI”) such as 1,5-NDI, and the combinations thereof. Examples of aliphatic isocyanates suitable for use according to this disclosure include, but are not limited to, isomers of hexamethylene dipolyisocyanate (“HDI”), isomers of isophorone dipolyisocyanate (“IPDI”), isomers of xylene dipolyisocyanate (“XDI”), isomers of methylene-bis-(4-cyclohexylisocyanate) (“HMDI”), and the combinations thereof. In some embodiments, the isocyanate monomers comprises diisocyanate monomers selected from the group consisting of isophorone diisocyanate (IPDI), methylene-bis-(4-cyclohexylisocyanate) (HMDI), hexamethylene diisocyanate (HDI), methylene diphenyl diisocyanate (MDI), toluene diisocyanate (TDI), and the combination thereof.

In some embodiments, the isocyanate component of the polyurethane foam composition can be prepared using any organic polyisocyanates, modified polyisocyanates, isocyanate based prepolymers, and mixtures thereof. These can include aliphatic and cycloaliphatic isocyanates, but aromatic and especially multifunctional aromatic isocyanates such as 2,4- and 2,6-toluenediisocyanate and the corresponding isomeric mixtures; 4,4′-, 2,4′- and 2,2′-diphenyl-methanediisocyanate (MDI) and the corresponding isomeric mixtures; mixtures of 4,4′-, 2,4′- and 2,2′-diphenylmethanediisocyanates and polyphenyl polymethylene polyisocyanates (PMDI); and mixtures of PMDI and toluene diisocyanates are preferred. Most preferably, the polyisocyanate used to prepare the prepolymer formulation of the present invention is MDI or PMDI or crude mixtures of any of these.

The isocyanate compounds are employed in an amount to obtain an NCO/OH ratio of the isocyanate component to the polyol component that is within the range of from 0.5:1 to 5:1, as described above.

In some embodiments, the isocyanate component can comprise one or more of the blowing agents and the flame retardants as described.

The isocyanate component can further comprise ingredient(s) selected from one or more of catalysts, surfactants, preservatives, pigments, colorants, antioxidants, biological retarding agents, reinforcing agents, stabilizers, fillers, and any combination thereof, as described herein.

In some embodiments, the isocyanate component can have a viscosity at 25° C. of from 150 mPa s to 20,000 mPa s, from 150 mPa s to 18,000 mPa s, or from 200 mPa s to 18,000 mPa s, as measured according to ASTM D2196.

Polyurethane Foam

Polyurethane foams can be formed from the polyurethane foam composition.

Generally, the polyurethane foam can be formed by (i) providing the polyurethane foam composition comprising (A) a polyol component and (B) an isocyanate component as described; (ii) forming a reaction mixture by mixing the (A) polyol component with the (B) isocyanate component; (iii) subjecting the reaction mixture to conditions such that reacts, expands, and cures to form a polyurethane foam.

The polyol component comprises one or more polyols, as described above. The one or more polyols comprised in the polyol component have an average hydroxyl group functionality of from 3 to 7 and an average hydroxyl group number of from 300 to 1000 mg KOH/g, and are selected from polyester polyols, polyether polyols and any combination thereof. In some embodiments, the polyurethane foam composition comprises from 50 to 95 parts by weight of one or more polyols per 100 parts by weight the polyol component, for example, from 55 to 95, from 60 to 95, from 65 to 90, or from 70 to 90 parts by weight of the one or more polyols per 100 parts by weight the polyol component.

The isocyanate component comprises one or more isocyanate compounds reactive with the one or more polyols in the polyol component, as described above. The one or more isocyanate compounds are comprised so that the NCO/OH ratio of the isocyanate component to the polyol component is within the range of from 0.5:1 to 5:1.

One or more blowing agents are comprised in either or both of the polyol component and the isocyanate component. In some embodiments, at least one physical blowing agent selected from a hydrocarbon, hydrofluorocarbon, hydrochlorofluorocarbon, fluorocarbon, dialkyl ether or fluorine-substituted dialkyl ether, or any combination thereof is comprised, as described above. Typically, the blowing agent constitutes from 1 to 20 parts by weight per 100 parts by weight the polyol component.

Further, one or more flame retardants are comprised in either or both of the polyol component and the isocyanate component. In some embodiments, the one or more flame retardants comprised in the polyurethane foam are selected from non-solid flame retardants. Typically, from 1 to 40 parts by weight of a flame retardant per 100 parts by weight the polyol component are included.

In some embodiments, the reaction mixture reacts, expands and cures within an enclosed space to form polyurethane foam within said enclosed space. In some embodiments, the reaction mixture is allowed to react, expand and cure at room temperature or higher.

In some embodiments, the polyurethane foam formed from the polyurethane foam composition as described is rigid.

In some embodiments, the polyurethane foam formed from the polyurethane foam composition as described has a tensile strength at 25° C. of higher than 3.5 MPa, as measured according to ISO 527-2 in a standard atmosphere.

In some embodiments, the polyurethane foam formed from the polyurethane foam composition as described has a tensile strength at 65° C. of higher than 1.0 MPa, as measured according to ISO 527-2 at a temperature of 65° C.

In some embodiments, the polyurethane foam formed from the polyurethane foam composition as described includes no more than 15 percent by weight of a flame retardant, based on the total weight of the final foam. In some embodiments, the polyurethane foam formed from the polyurethane foam composition as described meets the V0 flammability requirement according to the UL-94 Standard, with the inclusion of no more than 15 percent by weight of a flame retardant, based on the total weight of the formed foam.

In some embodiments, the polyurethane foam formed from the polyurethane foam composition as described has a thermal conductivity of less than 0.05 W/(m·K) at 23° C., as measured according to ASTM C 518.

In a specific embodiment, the polyurethane foam formed from the polyurethane foam composition according to the present disclosure has a tensile strength at 25° C. of higher than 3.5 MPa, measured according to ISO 527-2 in a standard atmosphere, a thermal conductivity of less than 0.05 W/(m·K) as measured according to ASTM C 518, and meets the V0 flammability requirement according to the UL-94 Standard at a flame retardant level of no more than 15 percent by weight based on the total weight of the formed foam. In another specific embodiment, the polyurethane foam formed from the polyurethane foam composition as described has a tensile strength 25° C. of higher than 3.5 MPa and a tensile strength at 65° C. of higher than 1.0 MPa as measured according to ISO 527-2, a thermal conductivity of less than 0.05 W/(m·K) 23° C. as measured according to ASTM C 518, and meets the V0 flammability requirement according to the UL-94 Standard at a flame retardant level of no more than 15 percent by weight based on the total weight of the formed foam.

Application of the Polyurethane Foam Composition

The present disclosure further describes a method of potting a product (for example, a battery), by using the polyurethane foam composition as described.

In an exemplary embodiment, the method can comprise (i) providing the polyurethane foam composition comprising (A) a polyol component and (B) an isocyanate component as described; (ii) forming a reaction mixture by mixing the (A) polyol component with the (B) isocyanate component; (iii) injecting the reaction mixture into an enclosed space of the product and allowing the reaction mixture to react, expand and cure. In some embodiments, the reaction mixture is allowed to react, expand and cure under room temperature or at elevated temperature.

In some embodiments, the enclosed space is a mold, or a cavity of a mold. In these embodiments, the reaction mixture can be injected into mold through an opening to a desired density, and is allowed to react, expand and cure inside the mold with the opening closed. In some embodiments, one or more individual batteries are configured within the mold and the injected reaction mixture is contemplated to fill the gaps between the batteries. The mold is optionally heated to temperature of from 45 to 65° C. when demolding is needed. That is, in some embodiments, the reaction mixture is injected into an enclosed space at from 45 to 65° C. In some embodiments, the mold is under vacuum control during the reaction. It is understood that the injection weight can be controlled through the filling density, typically from 200 to 450 kg/m³, preferably from 250 to 350 kg/m³. In some embodiments, demolding, when needed, is performed 10-60 minutes or several hours after the reaction is started.

The present disclosure further provides a product comprising the polyurethane foam as described herein. In some embodiments, the product comprises the polyurethane foam as a potting material.

In some embodiments, the product is produced by potting a reaction mixture formed from the polyurethane foam composition into an enclosed space (for example, a mold) that defines the dimensions of the product, and allowing the reaction mixture to react, expand and cure, prior to an optional demolding step.

In some embodiments, the product is produced by using the method of potting a product according to the present disclosure.

Also described herein is use of the polyurethane foam composition (as described) for potting products.

### Examples

Some embodiments of the invention will now be described in the following Examples, wherein all parts and percentages are by weight unless otherwise specified.

Raw Materials

Raw materials used in the examples are listed and described in Table 1 below.

TABLE 1
Materials

| Ingredient | | | |
|---|---|---|---|
| Type | Product Name | Chemical Description, Chemical formula, or Structure, | Source |
| Polyol 1 | PS 3152 | Aromatic polyester polyol, f = 2.0, OH# 315, viscosity | Stepan |
| | | 2800@25° C. | |
| Polyol 2 | VORANOL ™ | Polyether polyol, f = 6.0; OH# 480, viscosity 35000 cSt@25° C. | Dow |
| | RN 482 | Sorbitol initiated propoxylated polyether polyol | |
| Polyol 3 | VORANOL ™ | Polyether polyol, f = 4.3; OH# 490, 6050 cSt@25° C. | Dow |
| | RN 490 | Sucrose glycering co-initiated propoxylated polyether polyol | |
| Polyol 4 | VORANOL ™ | Polyether polyol, f = 3.0; OH# 240, viscosity 250 cSt@25° C. | Dow |
| | 2070 | Glycerin initiated propoxylated polyether polyol | |
| Fire | TCPP | Trichloropropylphosphate; P = 9.5%, Cl = 32.4%, viscosity 65 | Yoke |
| retardant 1 | | mPa · s@25° C. | |
| Fire | TEP | Triethyl Phosphate, viscosity 1.6 mPa s@25° C. | Yoke |
| retardant 2 | | | |
| Surfactant | VORASURF ™ | Silicone surfactant | Dow |
| | DC-193 | | |
| Catalyst 1 | PC-8 | N,N-Dimethylcyclohexylamine, 98% | Evonik |
| Catalyst 2 | PC-41 | N,N′,N′-Dimethylaminopropylhexahydrotriazine | Evonik |
| Catalyst 3 | TMR-2 | N-(2-Hydroxypropyl)-N-trimethyl Ammonium Formate in | Evonik |
| | | Dipropylene Glycol | |
| Water | H2O | H2O | |
| Blowing | HCFC-141b | 1,1-Dichloro-1-fluoroethane | Sanmei |
| agent | | | |
| Isocyanate | VORAMER ™ | PMDI (standard 200 mPas PMDI), NCO content 31.4 wt % | Dow |
| | ME 3535 | | |

Sample Preparation

Polyurethane foam compositions were prepared according to the formulations listed in Table 2 below.

TABLE 2
Formulation of polyurethane foam composition

| Ingredient type | Unit | CE1 | CE2 | CE3 | CE4 | CE5 | CE6 | CE7 | IE1 | IE2 | IE3 | IE4 |
|---|---|---|---|---|---|---|---|---|---|---|---|---|
| VORANOL ™ | pbw * | | | | | 76.1 | 76.1 | | | | 66.1 | |
| RN 482 | | | | | | | | | | | | |
| VORANOL ™ | pbw | | | 20.0 | 20.0 | | | 84.1 | 25.0 | 76.1 | | 20.0 |
| RN 490 | | | | | | | | | | | | |
| VORANOL ™ | pbw | 84.1 | 76.1 | 56.1 | 64.1 | | | | 51.1 | | 10.0 | 31.1 |
| 2070 | | | | | | | | | | | | |
| PS 3152 | pbw | | | | | | | | | | | 25.0 |
| TCPP | pbw | 8.0 | 16.0 | 16.0 | 8.0 | 16.0 | | 8.0 | 16.0 | 16.0 | | 16.0 |
| TEP | pbw | | | | | | 16.0 | | | | 16.0 | |
| VORASURF ™ | pbw | 1.2 | 1.2 | 1.2 | 1.2 | 1.2 | 1.2 | 1.2 | 1.2 | 1.2 | 1.2 | 1.2 |
| DC-193 | | | | | | | | | | | | |
| PC-8 | pbw | 0.5 | 0.5 | 0.5 | 0.5 | 0.5 | 0.5 | 0.5 | 0.5 | 0.5 | 0.5 | 0.5 |
| PC-41 | pbw | 0.2 | 0.2 | 0.2 | 0.2 | 0.2 | 0.2 | 0.2 | 0.2 | 0.2 | 0.2 | 0.2 |
| TMR-2 | pbw | 0.2 | 0.2 | 0.2 | 0.2 | 0.2 | 0.2 | 0.2 | 0.2 | 0.2 | 0.2 | 0.2 |
| H2O | pbw | 0.3 | 0.3 | 0.3 | 0.3 | 0.3 | 0.3 | 0.3 | 0.3 | 0.3 | 0.3 | 0.3 |
| HCFC-141b | pbw | 5.5 | 5.5 | 5.5 | 5.5 | 5.5 | 5.5 | 5.5 | 5.5 | 5.5 | 5.5 | 5.5 |
| Blended | mg KOH/g | 240 | 240 | 306 | 300 | 482 | 482 | 490 | 322 | 490 | 450 | 330 |
| polyol OH# | | | | | | | | | | | | |
| Average | | 3.00 | 3.00 | 3.34 | 3.31 | 6.00 | 6.00 | 4.30 | 3.43 | 4.30 | 5.61 | 3.01 |
| blended | | | | | | | | | | | | |
| polyol | | | | | | | | | | | | |
| functionality | | | | | | | | | | | | |
| NCO/OH ratio | | 1.2 | 1.2 | 1.2 | 1.2 | 1.2 | 1.2 | 1.2 | 1.2 | 1.2 | 1.2 | 1.2 |

* pbw = parts by weight (based on the weight of the polyol component)

For each of the prepared samples, a fire retardant was present in an amount of no more than 15 percent by weight based on the total weight of the polyurethane foam composition.

The production of foams from the prepared compositions was conducted as follows.

Polyols, fire retardant, surfactant, chemical blowing agent and physical blowing agent were mixed to produce the blended polyol.

The reactivity and free rise density of the polyol composition with isocyanate through hand mixing or via use of the cannon high pressure machine was checked.

The hand foaming process was conducted with a lab bench mixer Heidolph PR 32. The raw materials' temperature was set at 23±5° C. and the mixing speed is set at 2000-3000 rpm. A free rise foam composition was poured into a cup and the reaction time (cream, gel, tack free) was determined. The foam typically reached a height of 15-20 cm. The surface foam was removed and the foam cut into 5*5*5 cm³ cube to measure the free rise density.

The high pressure machine foaming process was conducted with a 20-25° C. raw material temperature, 70-100 g/s output and 130 bar Polyol/Isocyanate pressure. A free rise foam was poured into a 20*20*20 cm³ wood box with a plastic bag and the reaction time (cream, gel, tack free) was determined and the foam typically reached a height of 15-25 cm. The surface foam was removed and the foam was cut into a 5*5*5 cm³ or 10*10*10 cm³ cube to measure the free rise density.

Foaming in Mold without Batteries

The mixed polyol and isocyanate were injected into 20*10*30 cm³ mold to 300 kg/m³ density. After curing the physical properties were evaluated.

Foaming in Mold with Batteries

2-7 layers cylinder batteries were installed into the mold.

The mold and cylinder battery were heated to temperature 45-65° C., which is recommended if demolding is needed.

The mixed polyol and isocyanate were injected into an open mold at the injection opening and the mold was then closed. At the beginning stage of closed mold injection, vacuum control through a pipe connected to the mold was optional. The injection weight was controlled through the filling density, typically 250-350 kg/m³ filling density applied. The filling density can be adjusted from 200-400 kg/m³ depending on battery pack design.

10-60 minutes or several hours later, the battery pack was demolded.

Mold temperature was found to be critical for fast demold or high production efficiency. 45-65° C. mold temperature was found as suitable range for fast demold performance and was confirmed after a series experiments conducted with a high pressure foaming machine.

Performance Evaluation and Analysis

Performances tested for the foams prepared from these formulations are listed in Table 3 below.

TABLE 3
Flow ability behavior and physical properties

| | | | | | | | | | | | | | |
|---|---|---|---|---|---|---|---|---|---|---|---|---|---|
| | | Require- | | | | | | | | | | | |
| Items | Unit | ments | CE1 | CE2 | CE3 | CE4 | CE5 | CE6 | CE7 | IE1 | IE2 | IE3 | IE4 |

| | | | | | | | | | | | |
|---|---|---|---|---|---|---|---|---|---|---|---|
| Flow | excel- | excel- | excel- | excel- | poor | poor | good | excel- | excel- | good | excel- |
| ability | lent | lent | lent | lent | | | | lent | lent | | lent |
| Behavior | | | | | | | | | | | |

Reactivity

| | | | | | | | | | | | | |
|---|---|---|---|---|---|---|---|---|---|---|---|---|
| Cream time | S | 30 | 30 | 36 | 31 | 40 | 35 | 36 | 31 | 49 | 40 | 23 |
| Gel time | S | 150 | 146 | 125 | 125 | 97 | 98 | 135 | 101 | 139 | 97 | 75 |
| Free | kg/m³ | 95.0 | 116.0 | 81.2 | 75.2 | 107.0 | 99.0 | 119.0 | 83.0 | 102.0 | 91.0 | 72.0 |
| rise | | | | | | | | | | | | |
| density | | | | | | | | | | | | |

Physical and mechanical properties

| | | | | | | | | | | | | | |
|---|---|---|---|---|---|---|---|---|---|---|---|---|---|
| Tensile | MPa | >3.5 | 2.82 | 1.63 | 3.40 | 3.85 | 2.82 | 3.24 | 4.93 | 3.69 | 4.94 | 3.65 | 4.06 |
| strength @25° | | | | | | | | | | | | | |
| C. | | | | | | | | | | | | | |
| Thermal | W/ | | 0.049 | 0.045 | 0.043 | 0.045 | 0.043 | 0.049 | 0.042 | 0.044 | 0.046 | 0.047 | 0.041 |
| conductivity@23° | (m · K) | | | | | | | | | | | | |
| C. | | | | | | | | | | | | | |
| Flammability | | V0 | fail | fail | pass | fail | pass | pass | fail | pass | pass | pass | pass |
| Tensile | MPa | >1.0 | 0.43 | 0.12 | 1.05 | 1.23 | 2.76 | 2.42 | 3.61 | 1.34 | 3.84 | 2.86 | 1.42 |
| strength@65° | | | | | | | | | | | | | |
| C. | | | | | | | | | | | | | |

Measurement Information

Physical property is measured according to current common test methods, such as ASTM standards or equal standards.

Tensile strength is measured based on ISO 527-2 and thermal conductivity is measured based on ASTM C 518.

Flame retardance of the polyurethane foam is measured based on UL 94 and all the test specimen thickness is 13 mm.

Flow ability behavior is related to reacting liquid and mixed polyol viscosity. It is rated as following:
Poor—Slow spreading and high viscosity.
Good—Medium spreading and medium viscosity
Excellent—Fast spreading and low viscosity.

The critical parameters to be met for the polyurethane foam for batteries potting application include:
Tensile strength at 25° C. of above 3.5 MPa;
Meet V0 flammability requirement according to the UL-94 Standard.

CE1 and CE2

Foams produced using the 3 functional polyol VORANOL 2070 as sole polyol failed to meet both the tensile strength specification and the V0 flammability requirement at both levels of 8% or 16% TCPP in the formulation.

CE2 and CE3

When 20% 4.3 functionality polyol RN 490 was added into polyol side, the tensile strength at 25° C. was increased significantly but was less than the required 3.5 MPa. This formulation passed the V0 flammability test.

CE3 and CE4

With TCPP reduction to 8% while keeping the high functional polyol RN 490 constant and increasing the 3-functional polyol content, the tensile strength at 25° C. increased to more than 3.85 MPa. However, this formulation failed to meet the V0 flammability standard.

CE5 and CE6

High functionality and high OH #polyol RN 482 was used with 16% TCPP or TEP in the polyol side. Both fail the tensile strength requirement and pass the V0 flammability test. Due to the use of the high functional polyol as sole polyol the foam made in CE5 and CE6 was brittle and friable which resulted in the observed low tensile strength. In addition, the polyol blend viscosity of CE5 and CE6 was very high due to the high viscosity of RN 482. TEP has similar flammability performance to TCPP. While the viscosity of TEP is significantly lower in comparison to TCPP, it didn't reduce the initial viscosity sufficiently to improve the initial flow of the reacting liquid. Therefore, the flow processing to fill the gaps between batteries was poor for both examples.

IE1 and CE3

The tensile strength at 25° C. of IE1 was increased from 3.40 MPa to 3.69 MPa (as compared to CE3), therefore the tensile strength requirement was met when the amount of RN 490 was increased from 20% to 25%.

As expected, IE1 passed the V0 flammability test.

This comparison illustrates the minimum content of higher functionality polyol needed to reach the required tensile strength in this system.

IE1 and IE2

When the high functional polyol RN 490 was used as a sole polyol it delivered higher tensile strength and also passed V0 flammability test.

IE2 and CE7

CE7 showed that only 8% TCPP in polyol side still failed to pass the V0 flammability test even with high functionality polyol RN 490 as sole polyol. This illustrates that both an adequate amount of high functional polyol RN 490 (CE3) and an adequate amount of flame retardant (CE7) are needed to meet the V0 flammability rating.

IE3 and CE5/CE6

Low OH #and low functionality polyol was helpful to improve the foam flexibility to increase tensile strength. In addition, the flow ability was improved due to the reduction of the overall viscosity of blended polyols. These examples showed a balance of physical foam properties and flow ability. This balance was achieved through a blend of pure sorbitol or sucrose initiated polyol with high OH #with 2 or 3 functionality polyol.

IE4 and CE3

25% polyester PS 3152 was used as replacement in IE4 as compared to VORANOL 2070 used in CE3, which delivered better tensile strength at 25° C. and passed V0 flammability test.

### SUMMARY

The above analysis shows that the amount of high functionality polyol correlates with an increased tensile strength. For the fire retardant, a content of 16 wt % based on the weight of the polyol component was observed to be needed for the formed foam to pass V0 flammability test with formulations containing at least 20 wt % high functional polyol. Good performance was reached (tensile strength, flammability, processing) when high functionality polyols were mixed with low functionality and low OH value polyols. Polyester polyols can also increase the tensile strength as replacement of 2-3 functionality polyol and improve V0 flammability performance.

These results suggest that the polyurethane foam composition according to the present disclosure having a polyol component comprising one or more polyols with an average functionality in a range of 3 to 7 and a hydroxyl group value ranged from 300 to 1000, mixed with an isocyanate component, produces a polyurethane foam that has a tensile strength at 25° C. of >3.5 MPa and meets the V0 flame retardant requirement, which is advantageously used for potting applications, for example, battery potting application where improved battery energy density is desired.

What is claimed is:

1. A polyurethane foam composition, comprising:
(A) a polyol component, comprising one or more polyols selected from the group consisting of a polyester polyol, a polyether polyol, and the combination thereof, wherein the one or more polyols have an average hydroxyl group functionality of from 3 to 7 and an average hydroxyl group number of from 300 to 1000 mg KOH/g; and
(B) an isocyanate component, comprising one or more isocyanate compounds;
wherein in either or both of the (A) polyol component and the (B) isocyanate component, the polyurethane foam composition further comprises one or more flame retardants in an amount of no more than 15 percent by weight based on the total weight of the polyurethane foam composition, and, one or more blowing agents; and
wherein the NCO/OH ratio of the isocyanate component to the polyol component is within the range of from 0.5:1 to 5:1.

2. The polyurethane foam composition of claim 1, wherein the one or more blowing agents comprise at least one physical blowing agent.

3. The polyurethane foam composition of claim 1, wherein the flame retardant is trichloropropylphosphate or triethyl phosphate.

4. The polyurethane foam composition of claim 1, wherein NCO/OH ratio of the isocyanate component to the polyol component is within the range of from 0.5:1 to 2.5:1.

5. A polyurethane foam prepared from the polyurethane foam composition of claim 1, wherein the polyurethane foam comprises no more than 15 percent by weight of a flame retardant, based on the total weight of the polyurethane foam, wherein the polyurethane foam has a tensile strength of higher than 3.5 MPa at 25° C., and wherein the polyurethane foam has a thermal conductivity of less than 0.05 W/(m·K) at 23° C.

6. The polyurethane foam of claim 5, wherein the polyurethane foam has a tensile strength of higher than 1.0 MPa at 65° C.

7. The polyurethane foam of claim 5, wherein the polyurethane foam passes V0 flammability test according to the UL-94 Standard.

8. A method of potting a battery comprising:
(i) forming a reaction mixture by mixing a polyol component with an isocyanate component; wherein,
(A) the polyol component, comprising one or more polyols selected from the group consisting of a polyester polyol, a polyether polyol, and the combination thereof, wherein the one or more polyols have an average hydroxyl group functionality of from 3 to 7 and an average hydroxyl group number of from 300 to 1000 mg KOH/g; and
(B) the isocyanate component, comprising one or more isocyanate compounds;
wherein in either or both of the (A) polyol component and the (B) isocyanate component, the polyurethane foam composition further comprises one or more flame retardants in an amount of no more than 15 percent by weight based on the total weight of the polyurethane foam composition, and, one or more blowing agents; and
wherein the NCO/OH ratio of the isocyanate component to the polyol component is within the range of from 0.5:1 to 5:1,
and
(ii) injecting the reaction mixture into an enclosed space of the battery and allowing the reaction mixture to react, expand and cure.

9. The method of potting a battery of claim 8, wherein the reaction mixture is allowed to react, expand and cure at room temperature or higher.

10. The method of potting a battery of claim 8, wherein the reaction mixture is injected into an enclosed space at from 45° C. to 65° C.
